(19) United States
(12) Patent Application Publication
(10) Pub. No.: US 2009/0204725 A1
(43) Pub. Date: Aug. 13, 2009

(54) WIMAX COMMUNICATION THROUGH WI-FI EMULATION

(75) Inventors: Hong Liu, Sammamish, WA (US); Abhishek Abhishek, Woodinville, WA (US); Peter Bergler, Duvall, WA (US); Mohammad Shabbir Alam, Redmond, WA (US); Wei Zhao, Bellevue, WA (US); Jiandong Ruan, Sammamish, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 12/030,346

(22) Filed: Feb. 13, 2008

(51) Int. Cl. G06F 15/16; G06F 9/44

(52) U.S. Cl. 709/246; 719/321

(57) ABSTRACT

A computer system with a software framework for supporting Wi-Fi communications that is used for WiMAX communications in a user friendly way. A Wi-Fi emulation component presents a driver interface to the framework that allows Wi-Fi user interfaces and control functions to operate with a WiMAX network card. Functions of the WiMAX card not supported through the framework may be translated within the emulation component to command objects that are passed by the framework to extensibility components. The extensibility components may be supplied in association with the network interface card. The emulation component also presents an interface to a driver for a WiMAX network interface card in a form that may interface directly with the framework, if the framework is modified to support WiMAX communications.

### BACKGROUND

Wireless communication provides significant flexibility to computer users. By communicating wirelessly, computer users may simply create a network or may have network connectivity as they move their computers from place to place. As a result, the number of computers with hardware to support wireless communication has significantly increased. In many instances, the hardware supports communication according to the Wi-Fi standard.

Many computers are configured with a software framework that supports Wi-Fi communication. The framework provides user interfaces and performs other functions associated with controlling or providing status associated with Wi-Fi communications. For example, the framework may collect information about Wi-Fi networks operating in the vicinity of the computer and present a user interface that allows a user to select a network to which the computer will connect.

Protocols for wireless communications, other than Wi-Fi, are known. One example of such a protocol is WiMAX, and wireless network cards that allow computers to communicate according to the WiMAX standard are commercially available. Driver software, which controls a network card, may be supplied with these cards. However, many computers do not contain software designed to interface with WiMAX drivers. Rather, software within the computer interacts with the driver software associated with these cards as if it were driver software for a traditional Ethernet network interface card. Thus, even a computer not specifically constructed to support WiMAX communication can communicate according to this standard.

### SUMMARY OF INVENTION

To improve a user experience associated with use of a new wireless technology, particularly on a computer containing software not specifically configured to support the new wireless technology, an emulator is provided so that components of the computer designed to support communication using a first wireless technology may be used with a second wireless technology. As a result, user interfaces, and other components that generate or receive status or control information associated with the first wireless technology may perform comparable functions when the second wireless technology is in use.

Operation of the emulator may be different for different commands. Some commands that either control or request status from a network card may be compatible with network cards operating according to either the first or second wireless technologies. The emulator may transfer these commands without significant change. In other instances, wireless network cards operating according to both the first and second wireless technologies may perform analogous functions but perform the function in response to commands of different formats. In these instances, the emulator may map a command and/or parameters associated with a command from a form suitable for one of the wireless technologies to a form suitable for the other. In yet other circumstances, wireless communication according to the second technology may involve functions not supported by the framework. Such functions may be supported by extensibility components and the emulator may identify and route commands to the extensibility components.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a sketch of an operating environment containing a computer according to an embodiment of the invention;

FIG. 2 is a block diagram showing selected components of a computer according to an embodiment of the invention;

FIG. 3 is a flow chart of a process performed in an emulator component according to an embodiment of the invention;

FIG. 4 is a sketch of data structures that may be used by an emulator component when performing a mapping according to embodiments of the invention;

FIG. 5 is a sketch of a user interface according to embodiments of the invention;

FIGS. 6A . . . 6E are sketches of user interfaces according to embodiments of the invention; and

FIG. 7 is a sketch of a kit containing a network interface card and software components according to an embodiment of the invention.

### DETAILED DESCRIPTION

The inventors have appreciated that an experience for a user of a computer communicating according to a wireless technology could be improved when the computer is not designed to support communication according to that wireless technology. By adapting a framework developed for a first wireless technology for use in support of a second wireless technology, status and control information presented to the user will be more meaningful than in accordance with the prior art in which unsupported wireless network types were emulated as basic wired networks.

With this framework, tools or services that provide a desirable user experience for wireless communication may be made available to the user, even though not specifically developed for the second wireless technology. In addition, by using extensibility features of the framework, functions associated with the second wireless technology for which there is no analog in the tools and services of the framework can be implemented through extensibility components.

For example, a wireless networking service that reports network location that was developed for the first wireless technology may function as intended even if the computer is connected to a network implemented with the second wireless technology. Similarly, wireless security components developed for the first wireless technology may be used for communication in accordance with the second wireless technology. Though, if the second wireless technology uses a security protocol not supported by the framework, operation according to that security protocol may be provided through an extensibility component.

As another example, network information for wireless networks according to either the first or second wireless technology may be presented in a consistent fashion. Networks communicating according to both the first and second wireless technologies may appear in a single list of available wireless networks. User interface components, such as those that report to the user that a wireless network is available or in range may also be used. As a further example, tools that provide statistics or other information meaningful for wireless communication may also be available for communications according to the second wireless technology.

As a specific example, such a framework could be used to allow a computer containing tools and services designed to support Wi-Fi communications to support WiMAX communications.

In some embodiments, an Independent Hardware Vendor (IHV) may provide a wireless network card, including driver software, that supports communication in accordance with the second protocol. To enable the IHV to provide functionality in addition to that provided in an operating system to support communication according to the first wireless protocol, the IHV or an Independent Software Vendor (ISV) may provide an extensibility component that can be accessed through an extensibility point of the framework. Through this extensibility point, a driver for the wireless network card may interact with additional software components provided separate from the framework to provide functions in connection with communications using the second wireless technology.

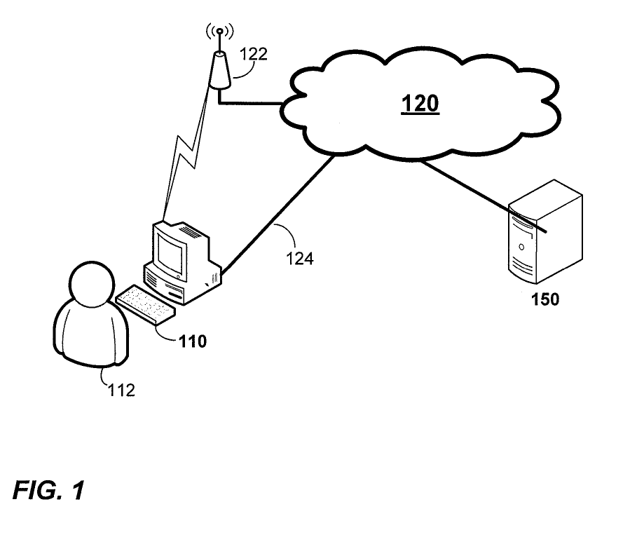

FIG. 1 illustrates an environment in which a computer configured according to embodiments of the invention may be used. In the example of FIG. 1, a user 112 of computer 110 may wish to use computer 110 to access one or more devices over a network. In the example illustrated, user 112 may access server 150, which is connected to network 120. Server 150 may represent any type of computing equipment that user 112 may wish to access, such as a file server or a web server. Likewise, network 120 may be any suitable network that may connect computer 110 with server 150 or any other suitable device.

In the embodiment illustrated, computer 110 may be connected to network 120 through a wired connection 124. Such a connection may be made using a network interface card within computer 110 that is configured to receive a cable connected to a router (not shown) or other access control device associated with network 120. Communications over wired connection 124 may be in accordance with the Ethernet protocol or any other suitable protocol.

Alternatively or additionally, computer 110 may be configured with a wireless network interface card, allowing computer 110 to access a network, such as network 120, using a wireless technology. In the example illustrated, wireless access to network 120 is provided through access point 122. To establish a wireless connection, access point 122 communicates according to the same wireless technology as the wireless network interface card installed within computer 110.

In this example, access point 122 may communicate according to the WiMAX standard. Likewise, a network interface card within computer 110 may configured to communicate according to WiMAX. However, in the embodiment illustrated computer 110 has an operating system that does not contain components constructed to support WiMAX communication. Rather, computer 110 includes a framework to support Wi-Fi wireless communications.

In accordance with the prior art, computer 110 could be configured to emulate wireless communications using components used for basic wired communication over wired connection 124. However, a more desirable user experience may be provided to user 112 by configuring computer 110 to implement a wireless connection to access point 122 using the framework provided within the operating system of computer 110 for Wi-Fi communication.

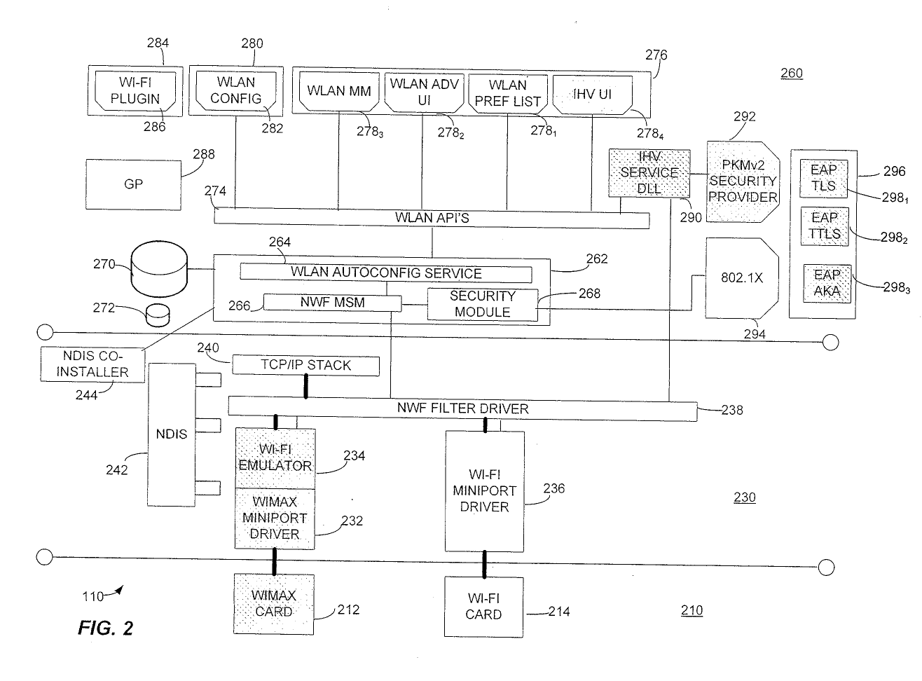

FIG. 2 illustrates components of computer 110, which may contain a Wi-Fi framework that is used to support communications according to the WiMAX standard. The architecture illustrated in FIG. 2 is segmented into a hardware mode 210, a kernel mode 230 and a user mode 260. In the example illustrated, components within hardware mode 210 are implemented as hardware components. Components within kernel mode 230 are software components implemented as part of an operating system for a computer. Components within user mode 260 are also software components that may be provided as part of the operating system. However, the software components within user mode 260 interface with the underlying hardware of a computer through components in kernel mode 230.

FIG. 2 provides an example embodiment only. It is not necessary that software components be separated into a kernel mode and a user mode as illustrated. Further, it is not necessary that components illustrated as being implemented in software be implemented in software or only in software. Some or all of the components could be implemented as programmable logic devices or other suitable hardware components. Similarly, some or all or the functions of components illustrated as being implemented in hardware could alternatively be implemented in software. For example, some or all of the functions performed by WiMAX card 212 or Wi-Fi card 214 could be implemented as part of a software defined radio.

Regardless of a specific implementation of the components, FIG. 2 illustrates that an architecture developed to support communications according to a first wireless technology, such as Wi-Fi, may also be used to support communications according to a second wireless technology, such as WiMAX.

FIG. 2 shows Wi-Fi card 214, which sends and receives radio signals according to the Wi-Fi standard. Wi-Fi card 214 may be a printed circuit board containing a radio and other circuitry that plugs into a bus (not shown) within computer 110. However, a “card” could be implemented in any suitable way. For example, the radio and other components could be mounted on a mother board or other assembly within computer 110. Further, Wi-Fi card 214 could be implemented by configuring a software defined radio or other configurable component to transmit and/or receive radio frequency signals according to the Wi-Fi standard. Accordingly, the specific implementation of Wi-Fi card 214 is not a limitation of the invention.

Regardless of how Wi-Fi card 214 is implemented, an interface to Wi-Fi card 214 is provided by Wi-Fi miniport driver 236. Wi-Fi miniport driver 236 may be a software component implemented as is known in the art. Driver 236 may receive commands specifying either the configuration or operations to be performed by Wi-Fi card 214. In response, Wi-Fi miniport driver 236 will generate the appropriate control signals to the underlying hardware of Wi-Fi card 214. Wi-Fi miniport driver 236 also may receive status information from Wi-Fi card 214. The status information may relate to Wi-Fi card 214 or operating conditions experienced by Wi-Fi card 214. Additionally, Wi-Fi miniport driver 236 may receive data for transmission. In response, Wi-Fi miniport driver 236 will provide the data to Wi-Fi card 214 in a format for transmission according to the Wi-Fi standard. Conversely, Wi-Fi miniport driver 236 may obtain from Wi-Fi card 214 data that has been received wirelessly.

Wi-Fi miniport driver 236 contains an interface or interfaces through which commands and status information as well as data for transmission or reception may be passed. The interface allows Wi-Fi miniport driver 236 to interact with other components in computer 110. In the embodiment illustrated, Wi-Fi miniport driver 236 includes a standardized driver interface. As a specific example, Wi-Fi miniport driver 236 may be configured to communicate according to the NDIS standard, illustrated in FIG. 2 by NDIS component 242. The NDIS standard allows command and status information to be exchanged as objects, referred to as OIDs. Each OID may be associated with a command that specifies a function or a type of status information. An OID may have an identifier, identifying the specific function or type of status information being conveyed by the OID, and may include one or more parameters relating to a function or a specific type of status associated with the OID. However, the specific form of interface supported by Wi-Fi miniport driver 236 is not critical to the invention and any suitable interface may be used.

In the example of FIG. 2, Wi-Fi miniport driver 236 interfaces with other software components within computer 110 through a Wi-Fi filter driver 238. Filter driver 238 also includes a standard interface, such as an NDIS interface, to allow it to easily interface with other components in computer 110. In this example, filter driver 238 may perform networking functions associated with the control of a network interface that are not unique to a specific Wi-Fi card, such as card 214. By implementing some functions in filter driver 238, the same software component may be used for different network interface cards and the functionality that needs to be implemented by a driver associated with a specific network interface card is reduced. Specifically, in the example of FIG. 2, Wi-Fi miniport driver 236 does not need to implement any of the functions already implemented in filter driver 238. However, FIG. 2 is only an example embodiment, and the driver functions implemented in computer 110 may be partitioned between components in any suitable way.

Regardless of the specific partitioning of the driver or drivers for Wi-Fi card 214, the NDIS interface associated with the drivers allows other components, such as TCP/IP stack 240, to interface with the drivers for sending or receiving commands and status information and data received or to be transmitted wirelessly. TCP/IP stack 240 may be a component as is known in the art or may be implemented in any suitable way. In this example, TCP/IP stack 240 provides an interface to application components (not shown) for network communications. As an example, a driver associated with Wi-Fi card 214 may provide to TCP/IP stack 240 data received wirelessly by Wi-Fi card 214. TCP/IP stack 240 may then route this data to an appropriate application component operating within computer 110. It should be appreciated that FIG. 2 illustrates an example embodiment only. It is not necessary that computer 110 communicate using a TCP/IP protocol, and any suitable protocol or protocols may be employed, and computer 110 may contain different or additional stacks.

Computer 110 may contain other components to perform control or status functions related to Wi-Fi communications. One such component is auto-configuration service 262. Auto-configuration service 262 provides a mechanism by which a network interface card and associated driver may be configured for wireless communication and status information may be routed to other components as is known in the art. In this example, auto-configuration service 262 may be implemented as a software component supporting client/server interfaces with other software components. However, the specific form in which auto-configuration service 262 interfaces with other components is not critical to the invention and any suitable types of interface may be used.

In the example illustrated, auto-configuration service 262 includes a Wireless Local Area Network (WLAN) auto-configuration service module 264. WLAN auto-configuration service module 264 may contain code that performs functions of auto-configuration service 262 that are not unique to Wi-Fi communications. In the example illustrated, functions unique to Wi-Fi may be implemented in native Wi-Fi module 266, and other functions may be performed within WLAN auto-configuration service module 262. Partitioning functionality between WLAN auto-configuration service module 264 and native Wi-Fi module 266 allows auto-configuration service 262 to be configured specifically for Wi-Fi communications. However, any suitable partitioning of functions may be used.

Auto-configuration service 262 may obtain from other components information for configuring Wi-Fi card 214 and its associated drivers. Some of the information used by auto-configuration service 262 may come from profile store 270. Profile store 270 may contain information, or “profiles,” relating to wireless networks to which computer 110 may connect. Auto-configuration service 262 may write information into profile store defining an appropriate configuration of Wi-Fi card 214 and its associated drivers upon making connection to a network. Subsequently, auto-configuration service 262 may retrieve this information and use it to reconfigure Wi-Fi card 214 and its associated drivers to reconnect to that network. In addition, user supplied information, including user preferences about networks to which computer 110 is permitted to connect, an order of preference of networks to which computer 110 should attempt to connect or other information may also be written to profile store and later used in operation of auto-configuration service 262.

Profile store 270 may be implemented in any suitable way, including as a file or other data structure written to a disk or other non-volatile storage medium within computer 110.

Auto-configuration service 262 may also store information into logs 272. Logs 272 also may be implemented as files or other data structures written to a disk or other suitable storage medium associated with computer 110. The information written to logs 272 may define events associated with wireless communications. This information may later be used by other tools or components that analyze events associate with wireless communications, such as diagnostic applications that help a user resolve problems with wireless communications.

Other information used by auto-configuration service 262 may be obtained from other program components through WLAN APIs 274. WLAN APIs 274 may be implemented using conventional software technology for providing interfaces between components. However, the structure of APIs 274 is not critical to the invention and WLAN APIs 274 may be implemented in any suitable way.

Information passed through WLAN APIs 274 may be generated based on user input received by user interface components 276. Conversely, status information obtained by auto-configuration service 262 may be passed through WLAN APIs 274 to user interface components 276 for display to a user. Each of the user interface components may be implemented with computer executable instructions that provide information to a user and receive commands from a user through one or more input/output devices. Such information may be presented graphically on a computer screen, though any suitable form of user input/output device may be used.

Any suitable number and type of user interface components may be provided. In the example illustrated in FIG. 2, user interface components 278₁ . . . 278₃ are illustrated as providing user interfaces associated with Wi-Fi wireless network connections. For example, user interface component 278₁ may receive user input relating to a preferred wireless network or networks. Component 278₁ may also present information about available wireless networks to a user. That information may be formatted in accordance with the defined user preferences. For example, interface component 278₁ could present to a user a list of available wireless networks ordered in accordance with a defined user preference.

Other components within user interface components 276 may provide user interfaces to support other functions. For example, interface component 278₃ may provide an interface through which a user may view all available networks and choose which ones to connect to (and subsequently disconnect from).

User interface component 278₂ may likewise provide an interface through which a user may configure parameters of a wireless network or obtain status information. In this example, user interface component 278₂ may provide a wider range of information about a wireless network than interface component 278₃. Likewise, component 278₂ may provide a wider range of choices for parameters that may be configured by a user. Such an interface may be tailored for an “advanced user.” However, the specific function of each of the interface components is not critical to the invention, and the functions supported through the interfaces collectively defined by user interface components 276 may be allocated to specific user interface components in any suitable way.

WLAN APIs 274 may also support exchanges of information between auto-configuration service 262 and other types of components. In the example of FIG. 2, a net shell component 280 is provided. Such a shell component may support execution of one or more other components. In this example, a WLAN configuration component 282 may execute within net shell 280. WLAN configuration component 282 may be a software component containing computer executable instructions that at suitable times trigger actions that generate commands to Wi-Fi card 214 and associated drivers to configure computer 110 for wireless communications.

Computer 110 may additionally contain other tools or services for use in connection with wireless communication that ultimately involves transmission or reception of radio frequency signals at Wi-Fi card 214. As a further example, computer 110 may contain a network location awareness component 284. Such a component may, in response to a request from other software components, provide information defining the characteristics of a network to which computer 110 is connected. Network location awareness component 284 may be implemented as is known in the art or in any other suitable way. To facilitate providing information when computer 110 is connected to a Wi-Fi network, Wi-Fi plug-in 286 may execute within network location awareness component 284. Wi-Fi plug-in 286 may contain computer executable instructions that obtain status information from any one or more of the components illustrated in FIG. 2 so that characteristics of a Wi-Fi network may be determined.

Other components within computer 110 may likewise interact to support Wi-Fi communications. For example, FIG. 2 illustrates a group policy component 288. Group policy component 288 may be implemented as is known in the art or in any other suitable way. Group policy component 288 may perform one or more functions associated with managing computer 110 according to a group policy specified by a network administrator of a managed domain to which computer 110 may be domain joined. Such a component may be used by computers within enterprises, such as computers connected to a wide area network managed by a single company. Group policy component 288 may retrieve policy information from a server or other suitable source that may be used in configuring computer 110 for Wi-Fi communications. For example, the group policy information may specify networks to which computer 110 is allowed to connect or, conversely, networks to which computer 110 should not connect. Similarly, policy information obtained by group policy component 288 may specify levels of security or other parameters associated with wireless communications. However, the specific type of group policy information obtained by group policy component 288 and the manner in which it is used is not critical to the invention.

FIG. 2 illustrates other components that may also interface with auto-configuration service 262. For example, FIG. 2 illustrates an NDIS co-installer 244. NDIS co-installer 244 may contain computer executable instructions that are used during installation of an NDIS driver, such as Wi-Fi miniport driver 236. NDIS co-installer 244 may be implemented as is known in the art or in any other suitable way.

Other functions of auto-configuration service 262 are also illustrated in FIG. 2. For example, auto-configuration service 262 contains a security module 268. During the operation of a wireless computer connected to a wireless network, one or more security related operations may be performed. As an example, a client computer connecting to an access point may be required to authenticate itself to the access point. Authentication may entail sending and receiving a series of messages according to a specific security protocol. Because security protocols may change from time to time and different security protocols may be used by different networks, the components within computer 110 that implement the security related functions may be implemented modularly. In this example, security module 268 provides an interface to other security related components that are constructed to control exchanges of messages according to a specific protocol. Security module 268 may, at appropriate times, access other components to determine an appropriate message to send according to a specific security protocol or validate that a message received was in compliance with the security protocol.

In the example of FIG. 2, computer 110 is configured for operation according to an 802.1x security protocol. Accordingly, security module 268 interfaces with 802.1x module 294. 802.1x module 294 may be implemented as is known in the art or in any other suitable way. Such a module may generate or validate, in response to requests from security module 268, messages according to the 802.1x security protocol.

In some instances, security functions to be performed by a wireless computer may incorporate elements of an extensible protocol, referred to as EAP. Accordingly, computer 110 may include an EAP host 296. EAP host 296 may support one or more EAP modules, illustrated as modules 298₁, 298₂ and 298₃. Each of the EAP modules may support one or more security related functions. By providing EAP host 296, specific modules may be added or removed from computer 110 to support any suitable security functions, even if not implemented according to a defined standard. 802.1x module 294 may interface with EAP host 296 to access any of the installed EAP modules, thereby extending security functions performed by 802.1x module 294.

FIG. 2 illustrates that a range of tools and services that are provided within computer 110 to support Wi-Fi communications. Because Wi-Fi communications are widely available, the tools and services described in connection with FIG. 2 may be incorporated as part of an operating system of computer 110. If a user wishes to add a WiMAX network interface to computer 110, similar tools and services could be added to support WiMAX communications. However, the inventors have appreciated that such tools and services are not generally available. Consequently, if a WiMAX card is added to a current computer, the software in the computer may treat the WiMAX network connection that may be established using a WiMAX card as a basic, wired network. Tools and services provided for a connection to a basic, wired network would be available to control or obtain status information relating to the WiMAX network.

However, the inventors have appreciated that interfacing to a WiMAX network as if it were a basic, wired network does not provide aspects of a user experience that many users would like. Interfacing to a network in this fashion may in some instances be confusing to the user. Specifically, the inventors have recognized that many user interaction components that users have come to expect in connection with Wi-Fi networks are unavailable with or do not operate as expected WiMAX networks. As a result, the user experience of the WiMAX network is degraded.

FIG. 2 illustrates an approach by which a WiMAX network interface may be readily integrated into computer 110. The approach illustrated in FIG. 2 allows many wireless tools and services to be available for use with WiMAX networks so that computer 110 can provide a desired user experience without requiring extensive components constructed specifically for the WiMAX network.

As shown, WiMAX card 212 may be added in hardware mode 210. A WiMAX miniport driver 232 may be provide for WiMAX card 212. WiMAX miniport driver 232 may be specifically configured to interface with hardware components on WiMAX card 212. As with Wi-Fi miniport driver 236, WiMAX driver 232 may apply commands or obtain status information from WiMAX card 212.

Like Wi-Fi miniport driver 235, WiMAX miniport driver 232 may be implemented with a standard interface to allow it to interface with components of computer 110. In the example illustrated, WiMAX driver 232 is implemented with an NDIS interface. Such an interface may be similar to the NDIS interface supported by Wi-Fi miniport driver 236. However, the specific OIDs that may be passed through the NDIS interface of WiMAX miniport driver 232 may be different, in at least some respects, than the OIDs passed through the NDIS interface of Wi-Fi miniport driver 236. The different OIDs may reflect differences in the functionality supported by WiMAX card 212 as opposed to the functionality supported by Wi-Fi card 214.

In the embodiment illustrated, computer 110 does not contain tools or services to generate OIDs specific to WiMAX card 212. Rather, a Wi-Fi emulator 234 is installed between WiMAX miniport driver 232 and native Wi-Fi filter driver 238. Wi-Fi emulator converts between OIDs generated for Wi-Fi and those usable for WiMAX.

Wi-Fi emulator 234 may be constructed to be readily incorporated into an existing Wi-Fi framework. It provides, at one end, an interface of the same form presented by Wi-Fi miniport driver 236 so that it may easily interface to filter driver 238. At the other end, Wi-Fi emulator 234 presents an interface in the form supported by WiMAX miniport driver 232. In the example illustrated, both drivers support the same form of interface, accordingly, both interfaces provided by Wi-Fi emulator 234 are of the same form. In the specific example of FIG. 2, Wi-Fi emulator provides an NDIS interface to both native Wi-Fi filter driver 238 and WiMAX miniport driver 232.

In between the two interfaces, Wi-Fi emulator 234 translates command or status objects provided by native Wi-Fi filter driver 238 into a format that is meaningful to WiMAX miniport driver 232. Conversely, Wi-Fi emulator 234 converts command or status objects generated by WiMAX miniport driver 232 into a format that is meaningful to native Wi-Fi filter driver 238. Wi-Fi emulator 234 may make such translations based on a mapping of command objects supported by Wi-Fi miniport driver 236 to those supported WiMAX miniport driver 232.

In this way, tools and services provided to support Wi-Fi networks may operate in connection with a WiMAX network. For example, a WiMAX network may appear on a list of available wireless networks presented by user interface component 278₁ because, through the use of Wi-Fi emulator 234, a WiMAX interface will respond appropriately to a request for status information even though the request was generated by a component of the Wi-Fi framework. A user could access such a user interface to specify a preference for a WiMAX network, in the same way that the user could specify a preference for a Wi-Fi network.

In the same way, network location awareness component 284, based on information provided by Wi-Fi emulator 234, provide information in a form that indicates that computer 110 is connected to a wireless network and may also provide information that identifies the network type. Similarly, group policy information may be specified for WiMAX networks. Other functions implemented for Wi-Fi networks may similarly be implemented based on interactions through Wi-Fi emulator 234.

However, it is possible that some functions that may be desirable to perform in connection with operation of a WiMAX network cannot be performed by components of a Wi-Fi framework. In this scenario, extensible features of the Wi-Fi framework may be used to implement those functions. The extensibility features allow third party supplied software components to be integrated into the framework. The extensibility components may be provided by an Independent Hardware Vendor (IHV) supplying WiMAX card 212 or an Independent Software Vendor (ISV) supplying software independent of an operating system on computer 110 that supplies the Wi-Fi framework illustrated in FIG. 2.

In the example embodiment of FIG. 2, WLAN APIs 274 provide a defined interface for components of the Wi-Fi framework to interact with auto-configuration service 262. Extensibility components may similarly be constructed to interface through WLAN APIs 274. As a specific example, user interface component 278₄ may be added to support user interactions relating to WiMAX communications that have no analogy in Wi-Fi communications. As a specific example, user interface component 278₄ may provide a user interface that allows a user to configure features on WiMAX card 212 that do not exist on Wi-Fi card 214.

Commands and other information may be exchanged between user interface component 278₄ and WiMAX miniport driver 232 in any suitable way. In the example illustrated, user interface component 278₄, in response to user input, generates one or more commands containing identifiers unique to WiMAX communication. These commands may be passed through WLAN APIs 274, auto-configuration service 262 and Wi-Fi filter driver 238 to Wi-Fi emulator 234. Wi-Fi emulator 234 may be constructed to recognize the OIDs generated by the Wi-Fi filter driver on behalf of the user interface component 278₄ as OIDs unique to WiMAX communication and pass those OIDs to WiMAX miniport driver 232 without modification. Because the OIDs are in form meaningful for WiMAX communication, WiMAX miniport driver 232 may be programmed to appropriately respond to those OIDs.

In reverse, WiMAX miniport driver 232 may generate notifications associated with functions performed by extensibility components, such as user interface component 278₄. Wi-Fi emulator 234 may pass those notifications on without modification. Such notifications may pass through Wi-Fi filter driver 238, auto-configuration service 262 and WLAN APIs 274 to user interface component 278₄, where they may be appropriately processed. In this way, extensibility components may be added to the Wi-Fi framework of computer 110 to support any desired function that is not otherwise supported in the framework.

The types of components added as extensibility components need not be limited to user interface components. FIG. 2 illustrates that service DLL 290 may also be added to the framework to provide a service not otherwise supported by the Wi-Fi framework including interfacing to other components. In this example, service DLL 290 may be implemented as a dynamically linked library (DLL), as is known in the art. However, any suitable implementation may be used for extensibility components. In this example, service DLL 290 interfaces with the Wi-Fi framework through WLAN APIs 274. In the same way that user interface component 278₄ may generate commands unique to WiMAX communication, service DLL 290 may similarly generate commands. Likewise, WiMAX miniport driver 232 may generate notifications associated with functions provided by service DLL 290.

FIG. 2 illustrates that extensibility components are not limited to interfacing with the Wi-Fi framework of computer 110 through WLAN APIs 274. In addition to interfacing through WLAN APIs 274, service DLL 290 may interface directly with Wi-Fi filter driver 238. Regardless of the specific mechanism by which extensibility components interface with the Wi-Fi framework, such an interface may be used to exchange commands or other information between extensibility components and WiMAX miniport driver 232.

In the example illustrated, DLL 290 provides a mechanism to interface with other extensibility components. In this example, service DLL 290 is shown interfacing with PKMv2 security provider component 292. Because WiMAX communications use PKMv2 security rather than 802.1x, PKMv2 security provider component 292 is added to perform functions similar to those performed by 802.1x component 294, but using a different security protocol which is appropriate for WiMAX communication. As with component 294, component 292 may interface with EAP host 296. However, the specific EAP modules, such as modules 298₁, 298₂ and 298₃, may be selected specifically for use by PKMv2 security provider component 292.

Though not expressly shown, other components may interface through service DLL 290, allowing computer 110 to be configured for WiMAX communication or communication using any other wireless technology.

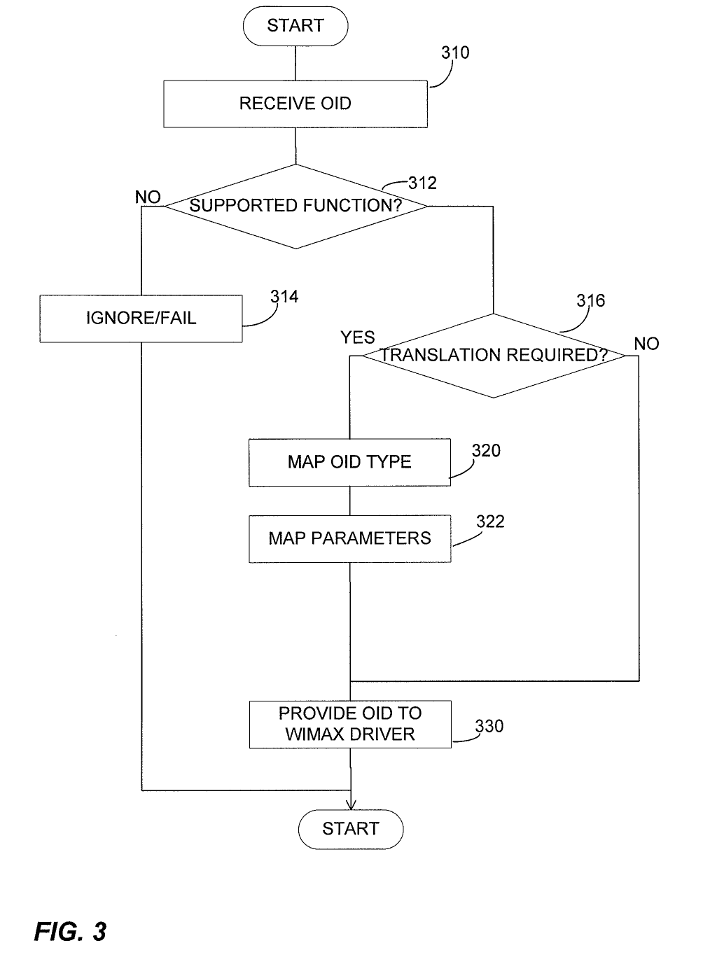

FIG. 3 illustrates a process by which Wi-Fi emulator 234 may operate to translate OIDs according to an embodiment of the invention. The process of FIG. 3 begins at block 310 where Wi-Fi emulator 234 receives an OID. The OID may be received by Wi-Fi emulator 234 through an NDIS interface or in any other suitable way.

The process proceeds to decision block 312. At decision block 312, the process branches depending on whether the received OID is associated with a function supported by WiMAX miniport driver 232 and/or WiMAX card 212. If the function is not supported, Wi-Fi emulator 234 may be unable to generate commands for the WiMAX network interface, provided by WiMAX miniport driver 232 and WiMAX card 212, to perform the function. Accordingly, the process may branch to block 314, where the OID is either ignored or fails. Depending on the interface standards used to communicate with Wi-Fi emulator 234, Wi-Fi emulator 234 may generate a response indicating that the command associated with the received OID fails. Though, in other embodiments or for other OIDs, if the interface does not support such a response, Wi-Fi emulator 234 may simply ignore the received OID and the process may end.

Conversely, if the received OID can be associated with a supported function, the process may branch from decision block 312 to decision block 316. At decision block 316 the process may again branch depending on whether the OID is directly supported by WiMAX miniport driver 232 or requires translation. If no translation is required, the process branches from decision block 316 to block 330, where the OID is provided to WiMAX miniport driver 232. WiMAX miniport driver 232 may thereafter respond appropriately to the OID.

Conversely, the process of FIG. 3 may branch from decision block 316 to block 320 when translation is required. Translation could involve changing type information associated with the OID, as is illustrated by processing at block 320. Alternatively or additionally, translation may involve mapping parameters, as is illustrated by processing at block 322. Following the mapping, the OID will be in a form that it can be processing by WiMAX miniport driver 232. Accordingly, the process proceeds to block 330 where the mapped OID is provided to WiMAX miniport 232.

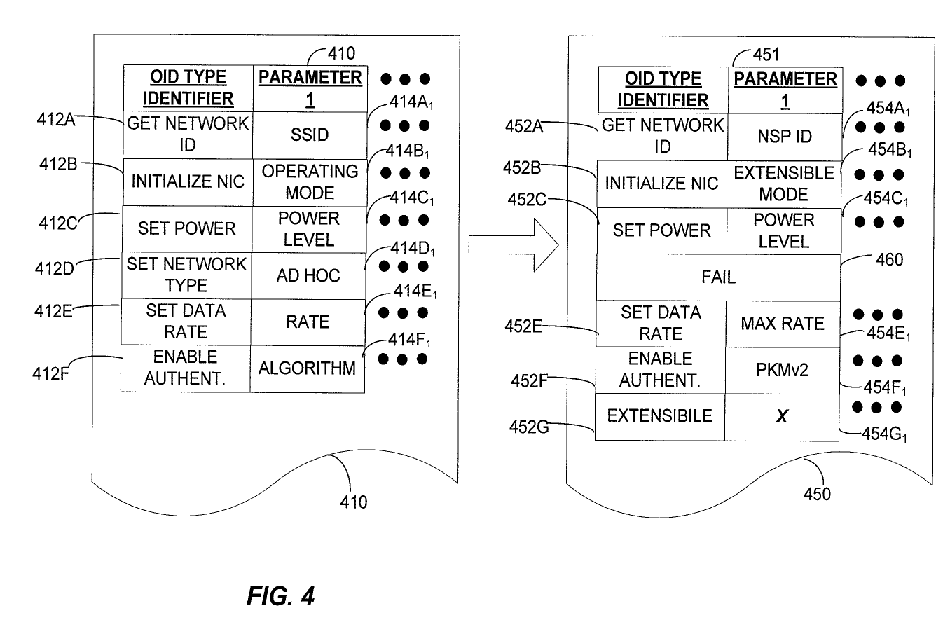

The mapping performed at blocks 320 and 322 may be performed in any suitable way. In accordance with one example embodiment, the mapping may be performed by maintaining tables of analogous functions. The tables may map OIDs that specify functions in connection with Wi-Fi communication to OIDs that specify analogous functions in connection with WiMAX communications. FIG. 4 provides an example of such mapping tables. FIG. 4 illustrates a data structure that may be used in mapping Wi-Fi OIDs to WiMAX OIDs. The same or similar data structure may be used in the reverse operation of mapping WiMAX notifications to Wi-Fi notifications.

In the example of FIG. 4, a table 411 of Wi-Fi OIDS is stored in computer readable media 410. Any suitable computer readable media may be used to store table 410. In an example embodiment, table 411 may be provided in conjunction with Wi-Fi emulator 234 (FIG. 2). In that scenario, computer readable media 410 may be a compute readable media storing computer executable instructions that implement Wi-Fi emulator 234. However, any suitable computer readable media may be used to store table 411.

The specific implementation of a data structure used in mapping OIDs is not critical to the invention. However, in the example embodiment of FIG. 4, each OID is represented by a row in a table. Table 411 contains multiple rows, each corresponding to an OID that a Wi-Fi framework may recognize. Each row contains one or more fields containing information that collectively define an OID. In this simple example of FIG. 4, two fields in each row are illustrated, one containing information identifying an OID type and another providing information specifying a parameter for the OID. For OIDs that do not have parameters, the second field may be omitted or blank. Alternatively, for OIDs that contain multiple parameters, more than one parameter field may be present.

In the simple example of FIG. 4, table 411 is shown to contain six rows, representing six different OIDs. A wireless technology framework may recognize more than six types of commands and status messages. Examples of commands processed by a wireless network interface that are not shown in FIG. 4 include commands to connect to a network, disconnect from a network, scan for available networks, enumerate available networks or provide statistics of a network connection. Accordingly, embodiments of the invention are likely to process more than six OIDs. Six OIDs are shown for simplicity, but any suitable number may be used.

In the example shown, the first row of table 411 contains fields 412A and 414A₁. Field 412A contains a value representing an OID type. Each OID will have a different type, allowing components processing the OID to associate a specific function or type of status information with the OID. The type may be represented in any suitable way, including as a text string, a binary value or other unique identifier. The identified parameters may be values provided to a driver in connection with the OID or returned by the driver after processing the OID.

For example, the first row illustrated in table 411 contains information in field 412A identifying the OID as a command to get a network identification. When such an OID is applied to a Wi-Fi driver, the driver returns the network SSID, as indicated in field 414A₁. Similarly, field 412B identifies an OID commanding the driver to initialize a network interface card. In response, the driver returns a value representing a mode in which the network interface card is operating, as represented by the value in field 414B₁.

The third row contains OIDs for which the associated parameters are provided to the driver. For example, field 412C contains a value indicating that the OID represented by that row is a command to set the transmit power level used by the network interface card. The associated parameter in field 414C₁ identifies the level at which the power should be set. Similarly, field 412D identifies the OID represented by that row as a command to the network interface card to set a network type.

The associated parameter in field 414D₁ identifies the type of network for which the network interface card is to be set. In this example, the type is “ad hoc” indicating that the network interface card should be set for communicating with an ad hoc network. The OIDs represented in the last two rows of table 411 similarly contain parameters provided to the driver for the network interface card for use in carrying out a specified command. In this example, field 412E identifies a command to set the data rate used by the network interface card and the associated parameter in field 414E₁ indicates the rate that the card should be configured to use for communication. Similarly, field 412F identifies a command for the driver to enable authentication. The associated parameter in field 414F₁ identifies an algorithm to be used in performing that authentication.

Table 451 provides information on WiMAX OIDs. Table 451 is here shown implemented in computer readable media 450. Computer readable media 450 may be the same structure as computer readable media 410 or may be implemented in any other suitable way.

Table 451, like table 411, contains multiple rows, each providing information about an OID. Correspondence between rows in table 451 and rows in table 411 is one mechanism by which a mapping between Wi-Fi OIDs and WiMAX OIDs may be specified. For example, the OID defined in the first row of table 411 may map to the OID defined in the first row of table 451, and vice versa. The OID defined in the second row of table 411 may map to the OID defined in the second row of table 451 and vice versa. The correspondence may continue for each of the other rows in the tables.

Any suitable form of mapping may be defined between each Wi-Fi OID and each WiMAX OID. The mapping may be one-to-one, one-to-many, many-to-one or for some OIDS, there may be no associated OID specified in the mapping. In addition, any or all of the elements of an OID may be the same or different than elements of an associated OID. For example, a WiMAX OID may have the same OID type identifier as an associated Wi-Fi OID. Though, in other instances, an OID may be mapped to an associated OID with a different OID type identifier. Similarly, each OID may be mapped to an associated OID with the same number and type of parameters. Though, in some instances, an OID will be mapped to an associated OID with a different number or type of parameters.

In the example of FIG. 4, an OID defining a “get network ID” command, as indicated by the value in field 412A, may map to an OID with a similar OID type identifier, as indicated by the value in field 452A. However, the parameter values may different based on different functionality supported by a Wi-Fi network card and a WiMAX network card. This difference is revealed by differences in the values of fields 414A₁ and 454A₁. Field 414A₁ reveals that when a get network ID command is performed by a driver for a Wi-Fi card, a value for the network SSID is returned. In contrast, a WiMAX network is not identified by an SSID. Accordingly, when a “get network ID” command is executed by a WiMAX driver, the driver may return an NSP ID, as indicated by the value in field 454A₁, which is used to identify WiMAX networks. Accordingly, based on the mapping indicated in FIG. 4, a value that is a suitable representation of a network name is returned in response to a get network ID command, regardless of whether that command is provided to a Wi-Fi driver or to a WiMAX driver through a Wi-Fi emulator.

Though, the mapping indicated in FIG. 4 is only one example of a possible mapping. In some embodiments, a “friendly name” used to identify a WiMAX network may be a more meaningful identifier of a network and, when used by a Wi-Fi framework in place of an SSID may achieve a result that is more meaningful to a user. Accordingly, an alternative mapping may associate a WiMAX command that returns a friendly network name with the Wi-Fi command for “get network ID.”

The second row in table 411 contains a value in field 412B indicating an “initialize network interface” command. In table 411, that command is associated with a parameter with a value in field 414B₁ that indicates an operating mode for which the network interface card should be configured when initialized. That command may be mapped to a WiMAX “initialize network interface card” command, as indicated by field 452B. In this example, the WiMAX network interface card supports only one mode of operation, the extensible mode. Accordingly, table 451 indicates that the “initialize network interface card” command in table 411 is mapped to an “initialize network interface card” command in table 451 in which the parameter is set to extensible mode, as indicated by the value in 454B₁. In this case, a Wi-Fi OID maps to a WiMAX OID of the same type but with different parameters.

The command defined in the third row of table 411 provides an example of a Wi-Fi command that may be mapped to a WiMAX command with the same OID type identifier and parameters. In this case, the values in fields 452C and 454C₁ may be the same as the values fields 412C and 414C₁.

The fourth row of tables 411 and 451 indicate a scenario in which there is no corresponding WiMAX command for a Wi-Fi command. In this case, the value in field 412D indicates a “set network type” command. The value in field 414D₁ is a parameter for that command, indicating that the network interface card should be set to “ad hoc mode.” As indicated in row 460 of table 451, the WiMAX network interface card cannot perform a corresponding function because it does not support ad hoc networks. Accordingly, the value in field 460 indicates that if such a command is provided to emulator 234, it will return a value indicating that the command failed. A similar result may occur for any combination of OID type identifiers and parameters that may be processed by a Wi-Fi driver that cannot processed by a WiMAX driver.

The final two rows of table 411 provide further examples of mappings for scenarios in which similar, though not identical, functions are available in both Wi-Fi and WiMAX network interface cards. Field 412E indicates a “set data rate” command. That command includes a value, as indicated by field 414E₁, identifying the rate for which the network interface card should be set. A WiMAX network card does not set its data rate in response to a value provided. Rather, it selects a maximum operating rate based on sensed channel conditions. Accordingly, a “set data rate” command, when applied to a WiMAX interface card, may have a different function than when applied to a Wi-Fi card. Here, as illustrated by the value in field 454E₁, if a “set data rate” command is received by Wi-Fi emulator 234 it will, rather than attempting to set the data rate used by WiMAX card 212, return as a parameter the maximum rate supported by the WiMAX card based on current channel conditions.

Similarly, the last row of table 411 indicates a command that does not map directly to a corresponding command for a WiMAX card. In this example, field 412F contains a value identifying an “enable authentication” command. An associated parameter, as indicated by the value in field 414F₁, identifies an algorithm to be used in performing authentication functions. Such information may be used by a Wi-Fi network interface, which can support multiple authentication algorithms. In contrast, the associated command, as indicated by the value in field 452F of table 451, does not include a parameter specifying one of many possible algorithms. As indicated by the value in field 454F₁, a WiMAX card may support only authentication according to PKMv2. Accordingly, Wi-Fi emulator 234 may convert any command indicating that authentication is to be enabled into a command indicating that authentication according to PKMv2 should be enabled.

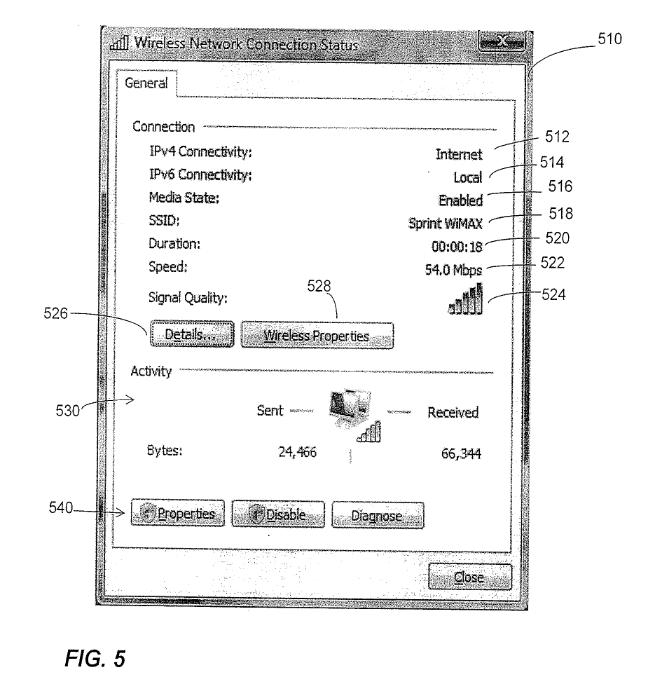

FIG. 4 illustrates some of the mappings that are possible to enable a WiMAX network interface to be used with a framework initially developed for Wi-Fi communications. FIG. 5 illustrates a consequence of making these mappings. FIG. 5 illustrates a user interface 510 that may be presented by one of the user interface components 276. The form of graphical user interface 510 is defined to present information relating a Wi-Fi network. However, because the commands used to obtain the information presented through graphical user interface 510 may be mapped to corresponding commands that may be executed by a WiMAX network interface, graphical user interface 510 may also present information relating to a WiMAX network.

Many of the elements of graphical user interface 510, which were defined to present information relating to a Wi-Fi network, have direct correspondence to information available for a WiMAX network. For example, fields 512, 514, 516, 520, 522 and 524 may all present types of information that can be obtained from either a Wi-Fi network interface or a WiMAX network interface. For example, the information presented in field 524 defines a signal quality. A user interface component rendering graphical user interface 510, in order to present information in field 524 about a network, may issue a command to the network interface to provide status information relating to signal quality. The information returned in response to such a command may be of the same type for either a Wi-Fi or WiMAX network. Accordingly, the same type of information may be presented in field 524 regardless of whether the information is obtained from a Wi-Fi network interface or a WiMAX network interface.

However, the value in field 518 indicates a scenario in which a mapping performed by Wi-Fi emulator 234 provides a different type of information that is nonetheless meaningful in the context displayed. Specifically, field 518 is labeled in user interface 510 to be providing information on a network SSID. As described above in connection with FIG. 4, a WiMAX network does not have an SSID. However, Wi-Fi emulator 232 may be configured to cause WiMAX miniport driver 232 to return a friendly name for a network in response to a command to provide an SSID. Accordingly, the user interface component rendering user interface 510, when requesting an SSID for a WiMAX network interface receives instead the networks friendly name. In this example, the friendly name of the WiMAX network is “Sprint WiMAX,” which appears in field 518. Though this information on a WiMAX network is not the same as the information that may be displayed for a Wi-Fi network, it is nonetheless meaningful to a user.

In the same way, commands that may be issued by a component rendering user interface 510 to obtain activity information for a Wi-Fi network may, when presented to a WiMAX network interface, cause the network interface to return information defining activity levels that may be presented in area 530. Thus, despite the fact that user interface 510 was initially defined in conjunction with a Wi-Fi network, it may be used in conjunction with a WiMAX network to provide activity information in field 530.

A similar result occurs when controls associated with user interface 510 are selected by a user. For example, when a user selects control 526, the component rendering user interface 510 may issue one or more commands requesting details on the connection maintained by a WiMAX network interface. The details presented may correspond directly to the details that would be presented for a Wi-Fi network, such as the values in fields 512, 514, 516, 520, 522 and 524. Alternatively, related values may be presented instead, as is the case with field 518. As a further alternative, though not illustrated in user interface 510, if user interface 510 is configured to present information on a Wi-Fi network connection for which there is no analogy in a WiMAX connection, the field may be left blank or otherwise include some indication that such information is unavailable. Similar results may occur if a user accesses control 528, requesting information on wireless properties.

In a similar fashion, commands that may be issued when a user selects a control from control area 540, even though initially defined to be applied to a Wi-Fi network interface, may nonetheless cause their intended function when applied to a WiMAX network interface through a Wi-Fi emulator, such as the emulator 234 illustrated in FIG. 2. In this way, software implementing a specific tool, originally developed for Wi-Fi, provides an intuitive user experience when used in connection with a WiMAX network. Thus, FIG. 5 provides an example of how mapping Wi-Fi commands to WiMAX commands allows a framework initially defined for a Wi-Fi network to be used with a WiMAX network interface.

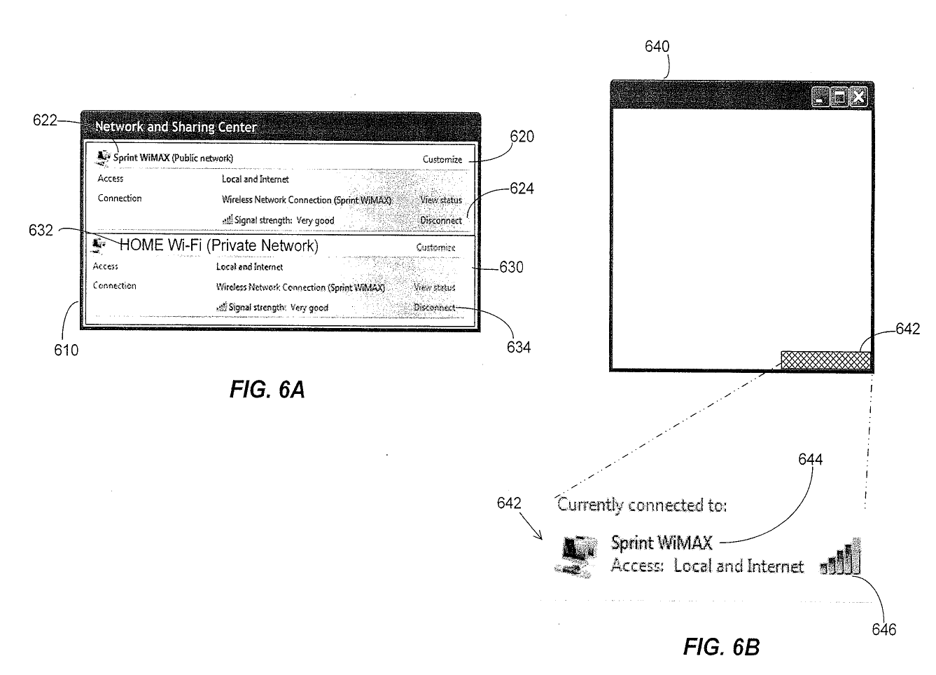

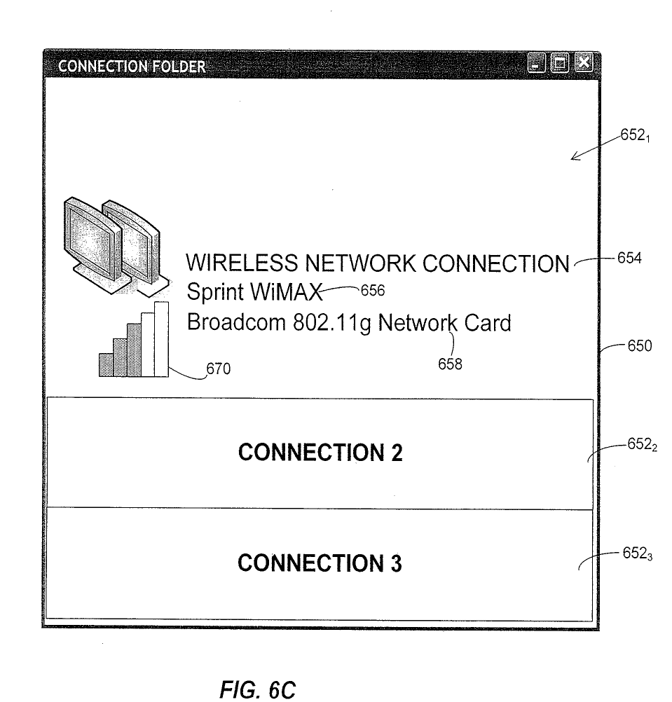

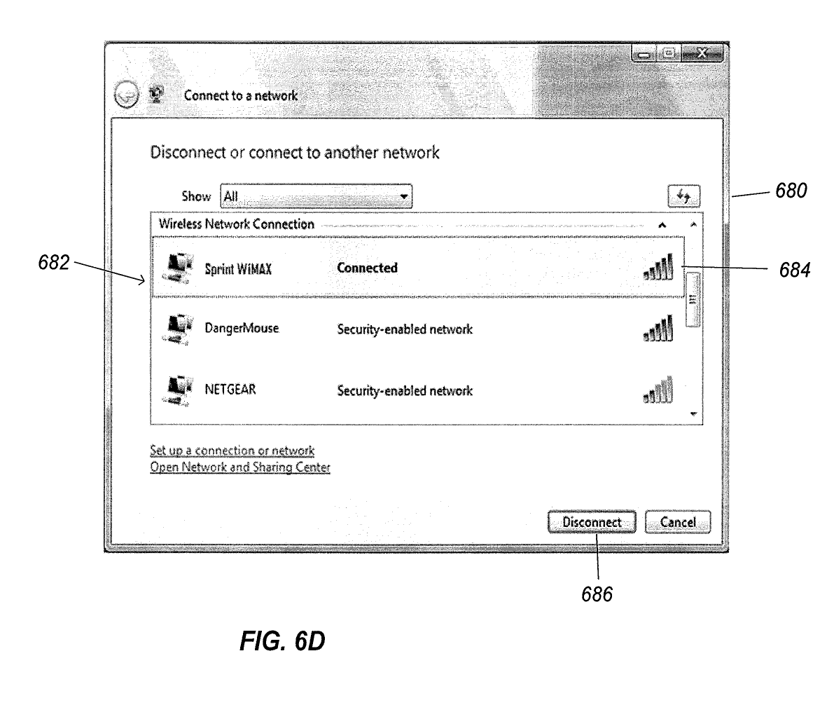

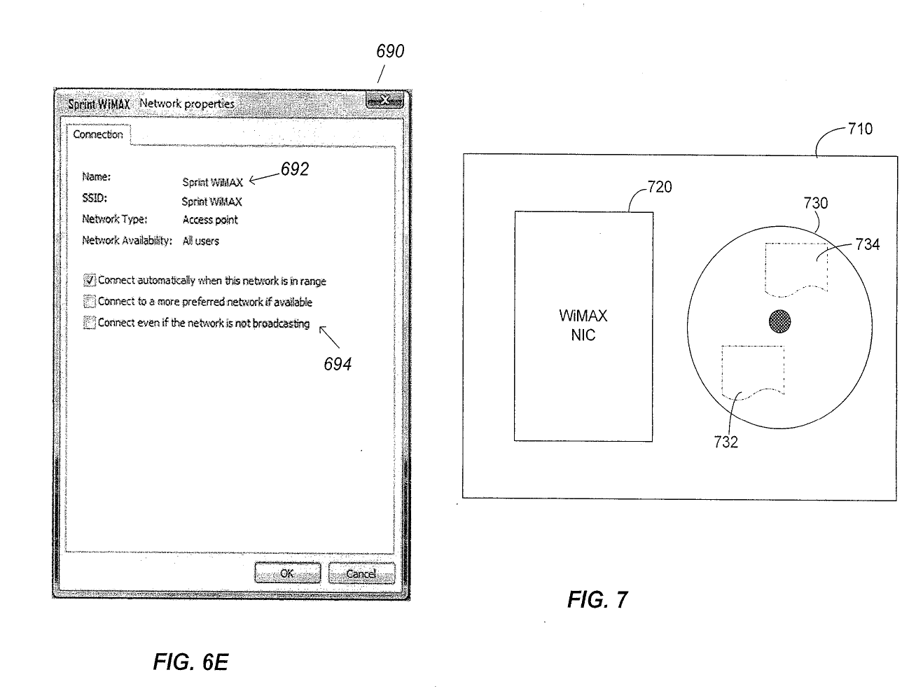

FIG. 6A illustrates a further result that may be achieved in some embodiments of the invention. FIG. 6A illustrates a user interface 610 that has been defined for use in conjunction with a Wi-Fi framework but can concurrently provide information about both Wi-Fi and WiMAX networks in an integrated fashion. In this example, user interface 610 provides panels through which a user may obtain information about each network to which computer 110 is connection and provide commands for controlling those networks. User interface 610 contains panels 620 and 630, each providing information about one network. In this example, panel 620 provides information about a WiMAX network, and panel 630 provides information about a Wi-Fi network. Though different types of network are in use, because user interface 610 is presented by a single framework, both types of networks may appear in the same user interface.

In this example, fields 622 and 632 provide the name and network type. As described above in connection with FIG. 4, a mapping may be supported such that a request for a network name may return a friendly name for a WiMAX network or an SSID when applied to a Wi-Fi network interface. Accordingly, field 622 shows the friendly name of the WiMAX network described in panel 620. Field 632 contains the SSID of the Wi-Fi network described in panel 630.

Additionally, each of fields 622 and 632 contains an indication of the network type of the described network. As described above in connection with FIG. 2, such information may be obtained by network location awareness component 284. Even though network location component 286 was initially constructed to obtain information on a Wi-Fi network, because of the mapping performed by Wi-Fi emulator 234, any commands issued by Wi-Fi plug-in 286 will return meaningful information even if applied to a WiMAX network interface. Accordingly, the format of information presented in panel 620 for a WiMAX network may be the same as the format of information presented in panel 630 for Wi-Fi network.

Controls in panel 630 that may be used to control a Wi-Fi network may similarly perform an intended result when used in panel 620 to control a WiMAX network. For example, controls 624 and 634, when activated, may cause the same result of disconnecting the computer from the network.

FIG. 6B illustrates a further scenario in which a framework developed for a Wi-Fi network may be used in connection with a WiMAX network. In this example, a user interface 640 is presented. User interface 640 includes a task tray 642. In a computer configured to support Wi-Fi communications, task tray 642 may contain information identifying a Wi-Fi network to which the computer is connected. Though the components that render interface 640 were initially configured to present information about Wi-Fi networks, those same components may function when a WiMAX network connection is established using the framework as illustrated in FIG. 2. Specifically, the display field 644 may contain the name returned when the components rendering interface 640 issued commands to request a network name. Similarly, the information in 646 may be generated with information returned by the WiMAX network interface in response to a command, even initially formatted for a Wi-Fi network interface, requesting status information relating to signal quality. Because, as a result of Wi-Fi emulator 234, such commands cause an appropriate response when applied to a WiMAX network interface, the same components used to render an interface 640 for a Wi-Fi network may be used to display corresponding information about a WiMAX network.

FIG. 6C illustrates a further user interface 650 initially defined for use in connection with Wi-Fi networks that may integrate information about WiMAX networks when a WiMAX network interface card is connected to the system according to embodiments of the invention. In this example, user interface 650 contains panels 652₁, 652₂ and 652₃, each providing information about a specific network connection. In this example, details of only panel 652₁ are shown. Each of the other panels may present the same type of information about other networks to which connections have been made. Though, for different types, different network types of information may be presented.

In this example, the network defined in panel 652₁ is a WiMAX network. Accordingly, though the information presented in panel 652₁ was obtained in response to commands initially defined for use in connection with Wi-Fi networks, execution of those commands results in meaningful information about a WiMAX network being displayed.

For example, each of fields 654, 656, 658 and 670 may present information obtained from a WiMAX network interface in response to commands initially defined for use in connection with a Wi-Fi network interface.

FIG. 6D illustrates a further user interface 680 through which a user may specify one or more actions to be taken with respect to a WiMAX network. In this example, user interface 680 presents a list of available wireless networks. In a computing device with an architecture as illustrated in FIG. 2, the list of networks may be obtained by media manager 278₃ (FIG. 2). User interface 680 may present a list 682 of available networks in conjunction with controls that allow actions to be taken with respect to those networks. In this example, item 684 in list 682 describes a WiMAX network. Accordingly, controls associated with user interface 680 may allow a user to take actions such as display all WiMAX networks, rescan for all visible WiMAX networks, connect to a WiMAX network or disconnect from a WiMAX network to which the computing device is connected.

In the state illustrated in FIG. 6D, list item 684 represents a WiMAX network for which a connection is established. In this state, control 686 indicates that, when the control is activated by a user the computing device should disconnect from that network. Other controls may be included to perform other desired functions. Alternatively or additionally, the function of control 686 may change depending on the state of a network connection or user input such that selecting control 686 may trigger operations relating to WiMAX networks appropriate in other context. Regardless of the specific operation, the operation may be executed by supplying commands to the WiMAX network interface card.

FIG. 6E illustrates a further user interface 690 that may present information concerning a WiMAX network. User interface 690 may, for example, be rendered on a display screen by IHV user interface component 278₄ (FIG. 2). Accordingly, user interface 690 may present information concerning WiMAX card 212 or allow a user to set preferences for operation of WiMAX card 212. With the architecture of FIG. 2, such a user interface may be readily integrated into a computing system.

The specific status information presented through user interface 690 is not critical to the invention and a manufacturer of a WiMAX card 212 or other party providing software for WiMAX card 212 may elect to present any one or more types of status information that WiMAX card 212 is capable of supplying. In the example of FIG. 6E, status information 692 relates to a connection being maintained by WiMAX card 212.

In the example of FIG. 6E, user interface 690 includes preference setting controls 694. When a user activates one or more of the preference setting controls 694, IHV user interface component 278₄ may provide information based on the control activated, to WiMAX card 212, causing WiMAX card 212 to be configured in accordance with the user settings. The specific parameters for which settings may be provided through user interface 690 is not critical to the invention, allowing an independent hardware vendor or other party preparing software for WiMAX card 212 to obtain user input setting any suitable parameter of WiMAX card 212.

As illustrated by the foregoing examples, a computer initially configured with a Wi-Fi framework may be adapted for WiMAX communications. Such an adaptation may be performed by adding a WiMAX network interface card and a relatively small number of software components that interface with a framework for Wi-Fi communication. The hardware and software components used to adapt a Wi-Fi capable computer for WiMAX communications, in some embodiments, may be sold as a kit. FIG. 7 illustrates such a kit 710.

Kit 710 here contains WiMAX network interface card 720 that may be installed in a computer in the same fashion that a Wi-Fi network interface card is installed. As is known in the art, a network interface card may be installed in a bus slot in computer 110. Though, any suitable method of installing a network interface card may be used.

In conjunction with the network interface card, a computer readable media, such a disk 730 may be provided. In the embodiment illustrated, the network interface card and the computer-readable medium are packaged together. It is not necessary that the components be simultaneously delivered to a user and other embodiments are possible.

The computer readable media may contain computer executable components such as components 732 and 734. These components may include a WiMAX miniport driver and a Wi-Fi emulator. In addition, the components may include one or more extensibility components, such as user interface component 278₄, service DLL 290, PKMv2 security provider component 292 or one or more EAP function modules, such as 298₁ . . . 298₃. In this way, components to reconfigure a computer for WiMAX communication may be readily provided. In addition, the same kit may be used to install WiMAX capabilities in a computer containing a framework for WiMAX communications. To use the kit in conjunction with such a computer, WiMAX network interface card 720 may be installed in conjunction with WiMAX miniport driver 232. Wi-Fi emulator 234 and any extensibility components for which comparable functionality is provided by the WiMAX framework need not be installed in this scenario.

The foregoing examples describe reconfiguration of a computer, initially configured for Wi-Fi communication, to communicate according to the WiMAX standard. However, the invention is not limited to use in conjunction with these wireless technologies. A computer configured for Wi-Fi communications may be reconfigured for communications in conjunction with any other suitable wireless technology. Similarly, the existing framework need not be limited to frameworks supporting Wi-Fi communication. A computer configured with any extensible wireless framework may be adapted for communication according to any other wireless technology as described above.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A computer storage media having a plurality of computer-executable components that, when executed on a computer, comprise:
a framework for interfacing to a driver for a wireless network card operating according to a first wireless technology;
a driver for controlling a wireless network card operating according to a second wireless technology; and
an interface between the framework and the driver for controlling a wireless network card operating according to a second wireless technology, the interface for converting status and command information between a format used by the framework for the first wireless technology and a format used by the wireless network card operating according to the second wireless technology.

2. The computer storage media of claim 1, wherein the first wireless technology comprises Wi-Fi and the second wireless technology comprises WiMAX.

3. The computer storage media of claim 2, in combination with a computer, the computer comprising a wireless network card operating according to the second wireless technology.

4. The computer storage media in the combination of claim 3, wherein the computer further comprises a wireless network card operating according to the first wireless technology.

5. The computer storage media of claim 2, wherein the framework is further adapted for interfacing to an extensibility component supplied separately from the framework the extensibility component for providing a user interface allowing a user to view and connect to or disconnect from a WiMAX network or configure settings for a WiMAX network.

6. The computer storage media of claim 1, wherein the interface presents a first standardized interface to the framework and a second standardized interface to the driver, the first standardized interface and the second standardized interface having the same format.

7. The computer storage media of claim 1, wherein:
the framework comprises a user interface component presenting a user interface having a field for status information relating to a network connection according to the first wireless technology, the user interface component adapted to issue a command requesting the status information; and
the interface is adapted to, in response to the command, obtain analogous status information from the driver and provide it to the user interface component, the analogous status information representing a condition of a network connection according to the second wireless technology.

8. The computer storage media of claim 7, further comprising a data structure mapping status and command information relating to the first wireless technology processed by the framework to status and command information relating to the second wireless technology processed by the driver.

9. The computer storage media of claim 8, wherein the status and command information comprises OIDs.

10. A kit comprising:
a wireless network interface card adapted for communication according to the WiMAX protocol;
computer storage media encoded with computer executable components comprising:
a driver adapted to interface to the network interface card, the driver having an NDIS interface;
an extensibility component adapted to perform at least one function associated with wireless communication using the WiMAX protocol that is not performed by a standard Wi-Fi network interface; and
an emulator component, adapted to translate between command objects processed by a Wi-Fi network interface and command objects processed by the driver and to format command objects from the driver for execution by the extensibility component.

11. The kit of claim 10, wherein the at least one function is a function not supported by a framework for Wi-Fi communication.

12. The kit of claim 10, in combination with a computer comprising a computer storage media having computer executable instructions that, when executed by the computer, comprise a framework for supporting Wi-Fi communication.

13. The kit in the combination of claim 12, wherein the computer executable instructions, when executed by the computer, further comprise an interface between the framework and the driver.

14. A method of operating a computer having a framework for supporting communication according to a first wireless technology according to a second wireless technology, the method comprising:
receiving a first command object in a format for execution by a network interface operating according to a first wireless technology;
mapping the first command object to a second command object; and
applying the second command object to a wireless network interface operating according a second wireless technology.

15. The method of claim 14, wherein:
the first command comprises setting an operating parameter of the first wireless technology that is not supported in the second wireless technology; and
the mapping comprises generating the second command object with an operating parameter supported by the second wireless technology in place of the operating parameter of the first wireless technology that is not supported.

16. The method of claim 14, further comprising:
generating, in a user interface component, the first command object;
receiving, in response to applying the second command object, a result; and
displaying, by the user interface component, the result.

17. The method of claim 16, wherein:
the first command object comprises a request for a network SSID; and
the mapping comprises mapping the first command object to a second command object that requests a friendly network name.

18. The method of claim 14, further comprising:
receiving a third command object in a format for execution by the network interface operating according to the first wireless technology, the third command object representing a function that is not supported in the second wireless technology; and
returning a failure in response to the first command.

19. The method of claim 18, wherein:
the first command object comprises a request for network statistics
the first wireless technology is Wi-Fi and the second wireless technology is WiMAX; and
the method further comprises displaying network statistics received in response to the second command object with a framework adapted for display of Wi-Fi network statistics.

20. The method of claim 19, wherein:
receiving the first command object comprises receiving the first command object through a first driver interface of a predefined format; and
applying the second command object comprises applying the second command object through a second driver interface of the predefined format.
